(19) United States
(12) Patent Application Publication
(10) Pub. No.: US 2003/0084353 A1
(43) Pub. Date: May 1, 2003

(54) System and method for predictive power ramping

(76) Inventors: Norman Chang, Fremont, CA (US); Zhenyu Tang, Foster City, CA (US); Osamu Samuel Nakagawa, Redwood City, CA (US); Shen Lin, Foster City, CA (US); Weize Xie, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 09/984,938

(22) Filed: Oct. 31, 2001

(51) Int. Cl. G06F 1/26

(52) U.S. Cl. 713/300

(57) ABSTRACT

Power surges in electrical systems, such as microprocessors, may be reduced by gradually applying power to resources, such as the floating point unit, to an active state. Also, performance penalty may be minimized by predicting ahead of time when a resource will be needed. In this manner, the power to the resource may be gradually applied so that the resource is active when it is actually needed. Modules may be included that predicts when a resource is needed based on instructions prefetched instruction from a pipeline of a microprocessor. Based on the prediction, power control modules may control the power to the necessary resource gradually.

### FIELD OF THE INVENTION

This invention relates generally to power control for such systems as computers, and more particularly to a prediction based power ramping.

### BACKGROUND OF THE INVENTION

Power surges in electronic circuits are problematic. This is particularly true in large scale digital integrated circuits, such as microprocessors. Large currents charge or discharge in a short period of time because of increasing numbers of transistors, increasing clock frequency and/or wider data paths in modern microprocessors. When a current I, passes through wires or substrate having an inductance L, a voltage is induced proportional to the rate of change of the current I, or more specifically, proportional to L(dI/dt). This voltage glitch is known as “L(dI/dt) noise,” “delta I noise,” “simultaneous switching noise,” “ground bounce,” or “power surge.”

As the sizes of the transistors shrink in a circuit, and therefore supply voltage decreases, the noise margin for the transistors is reduced and L(dI/dt) noise becomes especially troubling. If an L(dI/dt) voltage glitch exceeds the noise margin of a circuit, the circuit will misoperate as the transistors switch at wrong times and latch wrong values.

Moreover, dynamic throttling techniques exacerbate the power surge problem. Dynamic throttling techniques reduce power consumption by selectively throttling down or clock gating certain functional units that are not in use. The dynamic throttling techniques can lead to larger and more frequent power surges. The power surges may be described in terms of “step power”, which is the power difference between a previous and a present clock cycles. Step power is typically proportional to dI/dt.

A prominent example of a use of the dynamic throttling techniques is with floating point units (FPUs) of microprocessors. An FPU typically consumes 15%-18% of the total power of an operating microprocessor. The FPU may be throttled back (off state) to consume less energy when not needed, and powered on (on state) when needed. Hence, the step power of an FPU has a significant impact on power consumption and signal integrity of the overall microprocessor.

One conventional technique for mitigating the power surge associated with step power in a microprocessor is described in “Inductive Noise Reduction at the Architectural Level,” Int'l Conf. on VLSI Design, 2000, pp. 162-167; and “An Architectural Solution for the Inductive Noise Problem due to Clock Gating,” Int'l Symp. on Low Power Electronics and Design, 1999, pp. 255-257; both written by M. D. Pant, P. Pant, D. S. Wills and V. Tiwari, which are hereby incorporated by reference. This technique inserts “waking up” and “going to sleep” intervals between on and off states. The “waking up” interval is a time during which power is gradually increased, and the “going to sleep” interval is a time during which power is gradually decreased. This technique therefore reduces dI/dt or the rate of change of current. However, this technique causes a pipeline of a microprocessor to stall several clock cycles every time before the resource is available. The pipeline stalls significantly hamper performance of the microprocessor.

### SUMMARY OF THE INVENTION

In one respect, the invention relates to a method of reducing power surges. The method may include the steps of predicting a future time when a resource will need to be changed from a first state to a second state, and gradually changing power applied to the resource, over a transition time interval, such that the resource is in the second state by at least the future time. For example, the resource may be a floating point unit (FPU), arithmetic-logic unit (ALU), a multimedia unit such as a JPEG decoder, and the like. The first state may be the on or the operating state and the second state may be off state, or vice versa.

In another respect, the invention pertains to an apparatus for reducing power surges. The apparatus may include a resource usage prediction module predicting a future time when a resource will need to be changed from a first state to a second state, and a predictive power ramping module gradually changing power applied to the resource, over a transition time interval, such that the resource is in the second state by at least the future time.

Certain embodiments of the present invention may be capable of achieving certain aspects. For example, power savings may be achieved without compromising signal integrity with excessive L(dI/dt) noise without significantly hampering performance. Also, power savings and performance may be traded-off. Those skilled in the art will appreciate these and other benefits of various embodiments of the present invention upon reading the following detailed description of a preferred embodiment with reference to the below-listed drawings.

### BRIEF DESCRIPTION OF THE DRAWINGS

FIGS. 1A-1B depict graphs of power versus time of conventional electrical systems;

FIGS. 2A-2D depict graphs of power versus time of exemplary electrical systems of the present invention;

FIG. 3 is a block diagram of an pipeline microprocessor utilizing an exemplary embodiment of the present invention;

FIG. 4 illustrates a flowchart of an exemplary method, according to an embodiment of the present invention;

FIG. 5 is a block diagram of an exemplary power ramping clock distribution network, according to an embodiment of the present invention; and

FIGS. 6A-6D depict exemplary embodiments of a selective clock module.

### DETAILED DESCRIPTION

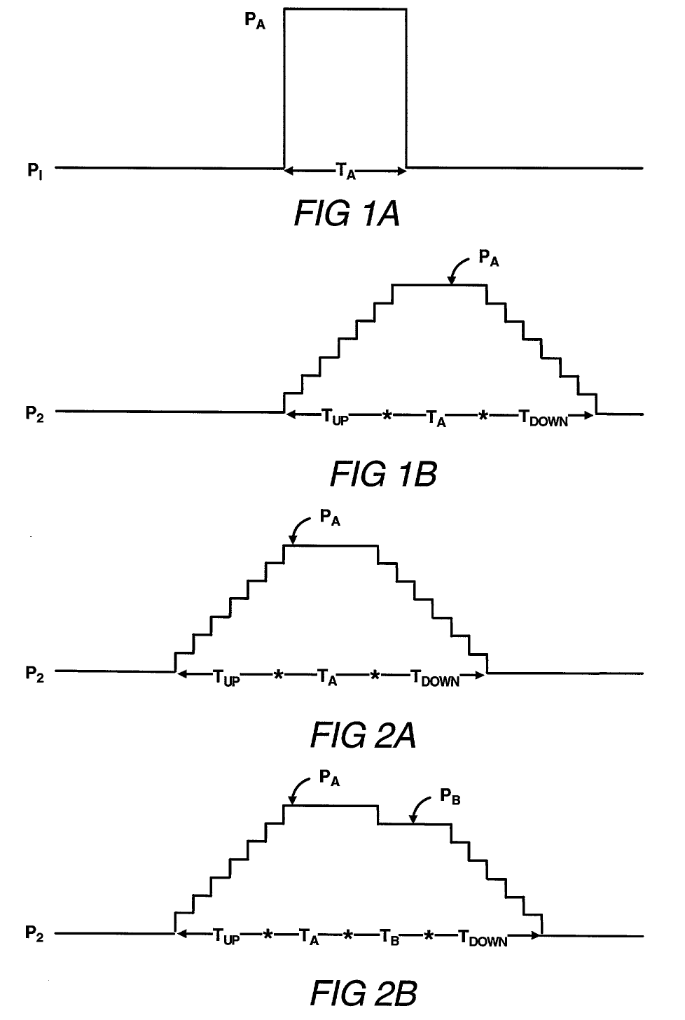

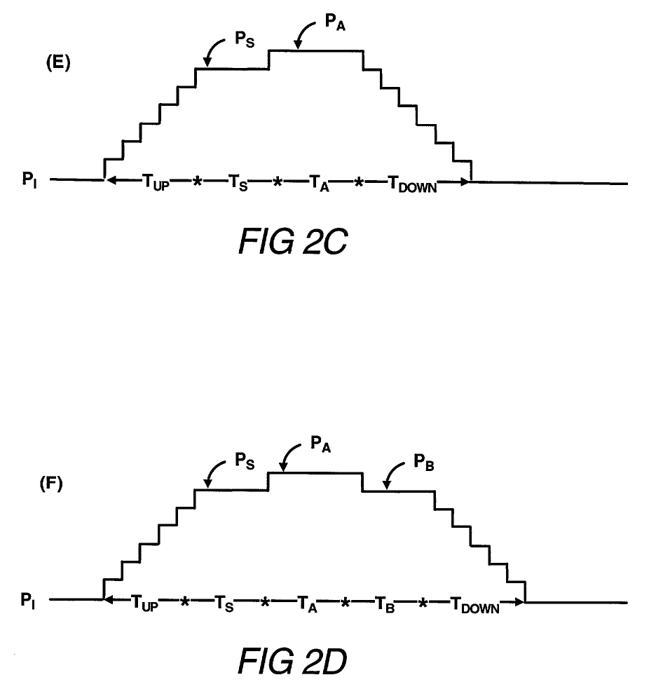

In an electrical system such as a microprocessor, power is related to current by the relationship P=IV, where V is the supply voltage (e.g., V_{DD} in an field effect transistor (FET) circuit), which is approximately a constant; therefore, except for a scale factor, the power profiles shown in FIGS. 1A-1B and 2A-2D are the same as current profiles for the same resource. FIGS. 1A and 1B show conventional power profiles, while FIGS. 2A through 2D show power profiles, according to embodiments of the present invention.

FIG. 1A shows the power profile of a conventional electrical device. As illustrated, the power shifts from an inactive power level P_{I} to an active level P_{A} abruptly. The power stays at the active level P_{A} for an active interval T_{A}, and then abruptly drops back to the inactive power level P_{I}. In a transistor circuit, the inactive power level P_{I} is due to current leakage across the transistors and is called “leakage power.” The transition from one state to another state typically occur in one clock cycle in the conventional device, i.e. ramping up or down occurs in one clock cycle. The step power in this instance is (P_{A}−P_{I}). Assuming that P_{I}=10% P_{A}, which is typically the case with contemporary digital integrated circuits, then the step power is P_{A}−P_{I}=0.9 P_{A}, which represents a large L(dI/dt) noise. Note that the value dI/dt is proportional to the clock frequency f of the device. Thus, faster clocks induce even larger noises, i.e. L(dI/dt) is proportional to Lf.

FIG. 1B shows the power versus time profile for a conventional resource or functional unit, according to a technique described in the Pant et al. articles cited above. According to this technique, when the resource is needed, power is gradually applied to the resource. After a “ramp up,” “power up” or “wake up” time T_{UP}, the power has risen to the active level P_{A}, where it remains for an active interval T_{A}. At the end of the active interval T_{A}, the power is gradually decreased down to the inactive level P_{I} over a “power down” or “going to sleep” interval T_{DOWN}. The power profile illustrated in FIG. 1B results in significantly less L(dI/dt) noise, but incurs a significant performance penalty by waiting during the power up time interval T_{UP} before utilizing the resource. For example, in a pipeline microprocessor, waiting for the microprocessor to power up causes stalls in the pipeline and negatively impacts performance.

FIG. 2A shows the power versus time profile for a resource or functional unit in an electrical system, according to a first embodiment of the present invention. As in the power profile of FIG. 1B, the power rises from the inactive power level P_{I} to the active level P_{A} gradually over the power up interval T_{UP}, and after the active interval T_{A}, the power is gradually decreased back to P_{I} over the power down interval T_{DOWN}.

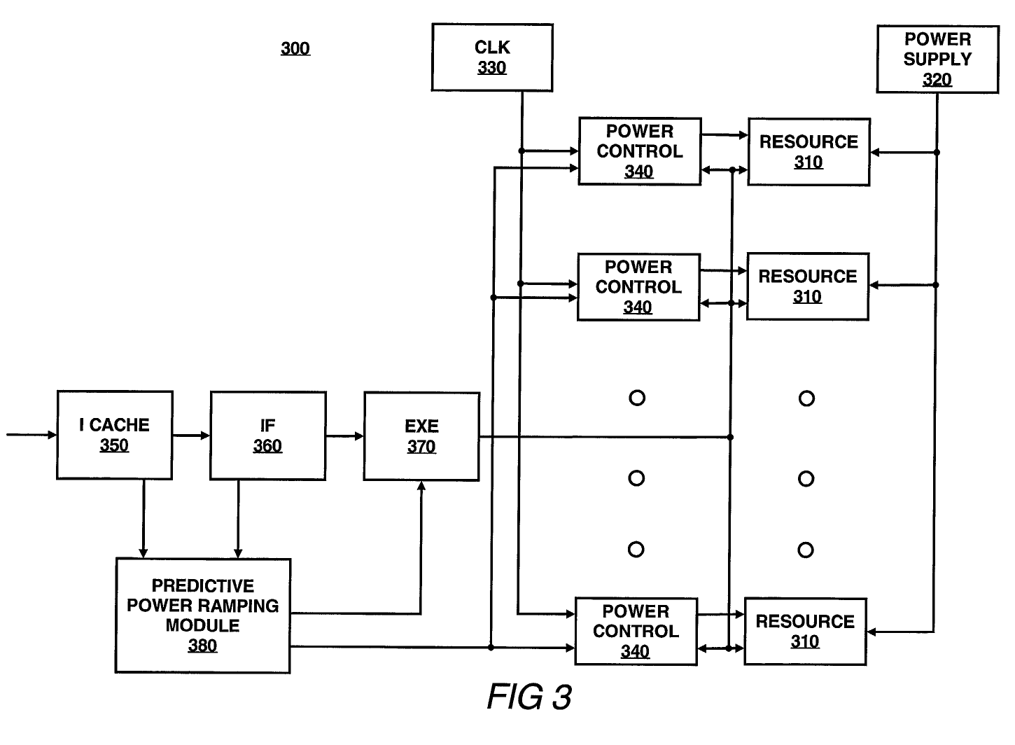

However, unlike the power profile in FIG. 1B, the power profile in FIG. 2A does not incur a performance penalty waiting for the resource to be powered up. Instead, the power is increased gradually some time before the resource is needed. In this manner, the performance penalty may be significantly reduced or even eliminated. The power can be gradually increased ahead of time because the time at which the resource is needed is predicted ahead of time. Techniques for predicting the resource's utilization are described below with reference to FIG. 3.

FIG. 2B shows the power versus time profile for a resource, according to a second embodiment of the present invention. The power rises from the inactive power level P_{I} to the active level P_{A} gradually over the power up interval T_{UP}. During the active interval T_{A}, the resource performs the needed operations. After the active interval T_{A}, the power is changed to a busy power level P_{B} for a busy interval T_{B}. If the resource is not needed again during the busy interval T_{B}, the power is gradually decreased to P_{I} over the power down interval T_{DOWN}.

While not shown in FIG. 2B, if the resource is needed again before expiration of the busy interval T_{B}, then the power is increased from the busy power level P_{B} to the active level P_{A} when or before the resource is needed. The busy power level P_{B} and the busy interval T_{B} are parameters that can be set to trade-off power consumption versus performance. For example, suppose that the resource has completed a task. The power for the resource then goes to the busy power state P_{B}. If the resource is needed within the duration T_{B}, then the power can change back to P_{A}, without having to experience a full ramp-up from the inactive power level P_{I}. Thus, longer the busy interval T_{B}, performance is enhanced. However, the busy power P_{B} is also relatively higher than inactive power state P_{I}. Thus longer the busy interval T_{B}, power consumption by the resource increases as well.

Also, the busy time interval T_{B} also provides way of gracefully recovering from a misprediction. Suppose, for instance, that the power is ramped up in expectation of utilization of the resource at a time T_{UP} in the future from the initiation of the ramping, but, as it turns out, the resource is not actually needed at that time. Then, the power would immediately change to the busy level P_{B}, and then ramp up to P_{A} when the resource is actually needed.

While FIG. 2B shows the change from P_{A} to P_{B} taking place immediately, it is within the scope of the invention for the change taking place incrementally, over an interval of time, before the state P_{B} is reached. In other words, generally, the resource changes from P_{A} state to P_{B} state over a first down transition time interval, then the resource remains in P_{B} state for the busy time interval, and then changes from P_{B} state to P_{I} state over a second down transition interval.

FIG. 2C shows the power versus time profile for a resource or functional unit in an electrical system, according to a third embodiment of the present invention. In this third embodiment, the power dwells at a subactive level P_{S} for some time before changing to the active level P_{A}. More specifically, the power rises from the inactive power level P_{I} to the subactive level P_{S} gradually over the power up interval T_{UP}. After dwelling at the subactive level for a subactive interval T_{S}, the power changes to the active level P_{A}. Reaching the subactive level early allows for mispredictions that are later than reality to be handled gracefully. Again, the parameters P_{S} and T_{S} also are parameters that may be set.

Again, like the second embodiment, while FIG. 2C shows the change from P_{I} to P_{S} taking place immediately, it is within the scope of the invention for the change taking place incrementally, over an interval of time, before the state P_{S} is reached. In other words, generally, the resource changes from P_{I} state to P_{S} state over a first up transition time interval (such as T_{UP}), then the resource remains in P_{S} state for the subactive time interval, and then changes from P_{S} state to P_{A} state over a second up transition interval (not shown on FIG. 2C).

FIG. 2D shows the power versus time profile for a resource, according to a fourth embodiment of the present invention. In this fourth embodiment, the power profile has both the subactive state before the active state and the busy state after the active state. This allows for misprediction in either direction to be handled.

By gradually increasing the power over an interval T_{UP}, the L(dI/dt) noise on power-up is decreased by a factor of T_{UP}. Recall that the step power again is (P_{A}−P_{I})/(ramp time). For example, if T_{UP} is 5 clock cycles, then using the values of a conventional integrated circuits as given above, the step power then becomes 0.90 P_{A}/5=0.18 P_{A}, which is a significant reduction in the L(dI/dt) noise relative to the conventional circuit. Similarly, by gradually decreasing the power over an interval T_{DOWN}, the L(dI/dt) noise on power-up is decreased by a factor of T_{DOWN}.

Although FIGS. 2A through 2D illustrate the gradual increases and decreases as being step-wise linear, this need not be the case. Any other profile of change is equally applicable and results in similar decrease in dI/dt. Also, the values of the parameters P_{S} and P_{B} need not be equal. Similarly, the values of the parameters T_{S} and T_{B}, or T_{UP} and T_{DOWN} need not be equal as well.

FIG. 3 illustrates an exemplary block diagram of a pipeline processor 300, according to an embodiment of the present invention. The processor 300 comprises several pipelined stages as well as several resources 310. Each of the resources 310 is connected to a power supply 320, by which power is supplied to the resources 310. Additionally, the resources 310 receive a clock signal originating from a clock 330. In this embodiment, the power consumption of the resources 310 is controlled by manipulation of the clock signal input to the resources 310. Power control modules 340 perform this function. The structure of the power control modules 340 may be a clock throttling circuit or a clock gating circuit. The resources 310 may be floating point processors, co-processors, arithmetic-logic units, nodes in a single-instruction-multiple-data (SIMD) array, or multimedia units such as a JPEG decoder, for example.

The processor 300 has several pipelined stages, including an instruction cache 350, an instruction fetch stage 360 and an execution stage 370. The operation of these stages is well known in the art. Briefly stated, the instruction cache 350 stores the next N instructions expected to be executed; the instruction fetch stage 360 fetches the instructions from the instruction cache 350 several cycles (e.g., two cycles) in advance of their execution; and the execution stage 370 executes the instructions.

Connected to the instruction cache 350, the instruction fetch stage 360 and the execution stage 370 is a predictive power ramping module 380. The predictive power ramping module 380, in conjunction with the power control modules 340, controls the power to the resources 310. The predictive power ramping module 380 prefetches instructions from the instruction cache 360. The prefetched instruction is pre-decoded to predict whether a particular resources will be needed in the future. If so, the predictive power ramping module 380 instructs the associated power control module 340 to ramp up the resource from the inactive state to active (or subactive) state. If the resource is predicted not to be needed after being used, the predictive power ramping module 380 instructs the power control module 340 to stay in subactive state or to ramp down to the inactive state.

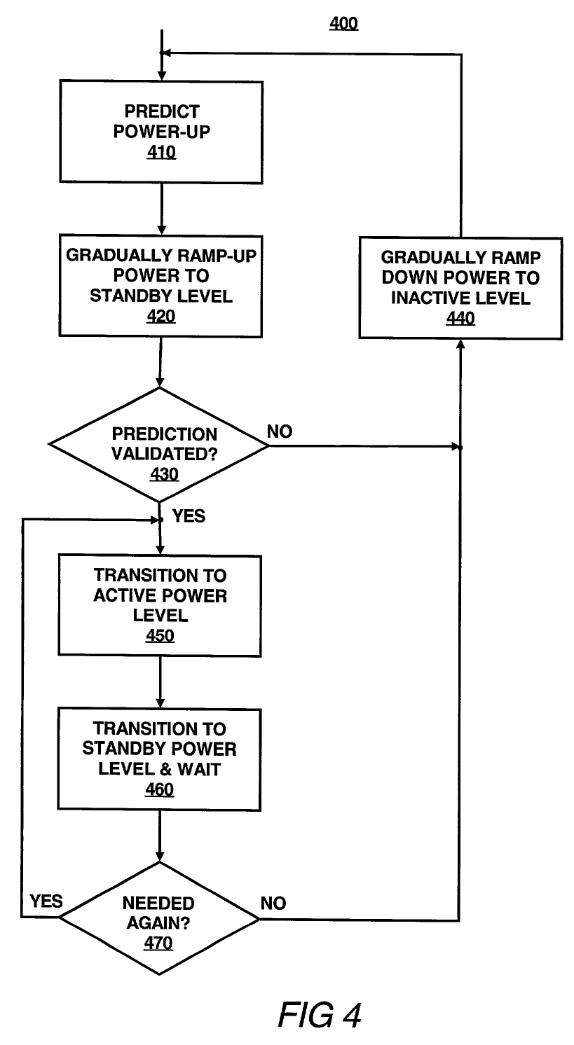

FIG. 4 is a flowchart of a method 400, according to an embodiment of the present invention. The method 400 may be implemented, for example, by the predictive power ramping module 380 and the power control modules 340 of FIG. 3. The method 400 begins by predicting (410) that a resources is needed in the fully powered state. The predicting step 410 may be accomplished by observing an event that is statistically correlated with the use of the resource. For example, in a pipelined microprocessor, the event may be the occurrence of a floating point instruction in an early stage of the pipeline. This example is discussed in greater detail with reference to FIG. 4 below.

In response to the predicting step 410, the method 400 gradually ramps up (420) the power supplied to the resource to at least the standby level P_{S}. Because power being ramped up in step 420 is gradual, ramping up occurs over some time interval, such as T_{UP} in FIGS. 2A-2D. At the expiration of that ramp-up interval, the method 400 validates (430) the prediction performed at step 410. In other words, the method 400 verifies that the prediction has come true (i.e., the resource indeed should be fully powered). If the prediction is not validated (430), then the method 400 gradually ramps down (440) the power supplied to the resource and returns to the initial state to await another prediction (410). Optionally, the validation step 430 is extended over some interval of time (i.e., T_{S} in FIG. 2D).

If, on the other hand, the prediction is validated (430), then the method 400 transitions (450) the power supplied to the resource from the standby level P_{S} to the active level P_{A}. The method 400 then dwells at the active level P_{A} for some time, typically as long as the resource is needed. Thereafter, the method 400 transitions from the active level P_{A} to the standby power level P_{S} and waits there for some time (i.e., T_{B} in FIG. 2D). During that waiting time, the method 400 checks (470) whether the resource is needed again. If so, the method 400 loops back to the transitioning step 450. If not, the method 400 loops back to the ramping down step 440.

FIG. 5 is a block diagram of an exemplary power ramping clock distribution network 500, according to an embodiment of the present invention. As shown, the network 500 includes a control register 510 and selective clock module 520. The control register 510 receives one or more external signals. These external signals may be software, hardware, or even firmware based. The external signals may indicate that one or more particular resources 510 may be needed in the future. The control register 510 sends to the selective clock module one or more signals on the control signal bus.

The selective clock module 520, based on the signals on the control signal bus, enables or disables one or more of the clock signals CLK₁ to CLK_{M}. These clock signals allow for particular resources to be clocked. For example, CLK₁ may supply the clock signal to the FPU and CLK₂ may supply the clock signal to the ALU. If a particular resource is not needed, then the associated AND gate may be disable. By supplying clock signals to the resources only when needed, power consumed by the electrical system may be minimized.

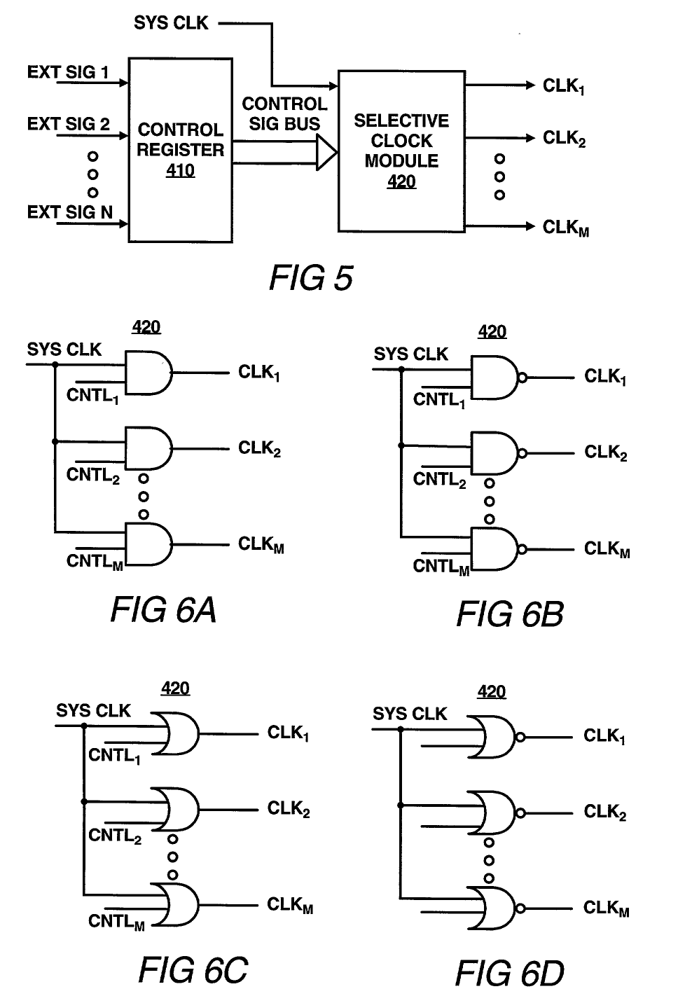

FIGS. 6A-6B show exemplary implementations of the selective clock module 520. FIG. 6A shows that the system clock SYSCLK is distributed to all AND gates. Each AND gate receives controls signals CNTL₁ to CNTL_{M}. It is seen that only when a particular control signal is in a high state, the corresponding clock signal is enabled. The implementation of FIG. 5B works similarly except that the phase of the output clock signal is substantially opposite to that of the system clock. In FIGS. 6C and 6D, OR and NOR gates are used, respectively. In these instances, the clock signals are enabled if input control signal to the gate is in a low state. One of ordinary skill in the arts will recognize that other implementations of the selective clock module 520 are possible and within the scope of the present invention.

What has been described and illustrated herein is a preferred embodiment of the present invention along with some of its variations. The terms, descriptions and figures used herein are set forth by way of illustration only and are not meant as limitations. Those skilled in the art will recognize that many variations are possible within the spirit and scope of the present invention, which is intended to be defined by the following claims—and their equivalents—in which all terms are meant in their broadest reasonable sense unless otherwise indicated.

What is claimed is:

1. A method to reduce power surge in an electrical system, comprising:
predicting a future time for a resource to be changed from a first state to a second state; and
changing a power applied to said resource to change a state of said resource from said first state said second state over a transition time interval by at least said future time.

2. The method of claim 1, wherein said first state is one of active and inactive states and said second state the other of said active and inactive states.

3. The method of claim 1, wherein said predicting step comprises:
prefetching an instruction from an instruction cache;
decoding said prefetched instruction; and
predicting said second state based on said decoded prefetched instruction.

4. The method of claim 1, wherein said gradually changing step comprises:
changing said power applied to said resource from said first state to an intermediate state over a first transition time interval;
maintaining said resource in said intermediate state for an intermediate time interval; and
changing said power applied to said resource from said intermediate state to said second state over a second transition time interval.

5. The method of claim 4, wherein said first state is an inactive state, said second state is an active state, and said intermediate state is a subactive state.

6. The method of claim 4, wherein said first state is an active state, said second state is an inactive state, and said intermediate state is a busy state.

7. The method of claim 4, wherein at least one of said first transition time interval, said intermediate time interval, and said second transition time interval is multiple clock cycles long.

8. The method of claim 7, wherein said power to said resource is changed incrementally at each clock cycle over at least from one of said first and second transition time intervals.

9. A power reduction module, comprising:
a predictive power ramping module predicting a future time when a resource will need to be changed from a first state to a second state; and
a power control module gradually changing power applied to said resource, over a transition time interval, such that said resource is in said second state by at least said future time.

10. The power reduction module of claim 9, wherein said first state is one of active and inactive states and said second state the other of said active and inactive states.

11. The power reduction module of claim 9, wherein said predictive power ramping module comprises:
an instruction prefetch module prefetching from an instruction cache; and
an instruction predecode module decoding the prefetched instruction to predict if said resource will need to be in said second state in said future time.

12. The power reduction module of claim 9, wherein said power control module changes power to said resource from said first state to an intermediate state over a first transition time interval, keeps said resource in said intermediate state for an intermediate time interval, and changes power to said resource from said intermediate state to said second state over a second transition time interval.

13. The power reduction module of claim 12, wherein at least one of said first transition time interval, said intermediate time interval, and said second transition time interval is multiple clock cycles long.

14. The power reduction module of claim 13, wherein said power control module changes power to said resource incrementally at each clock cycle over at least from one of said first and second transition time intervals.

15. The power reduction module of claim 9, wherein said power control module includes:
a control register receiving one or more external signals and sending out one or more clock control signals indicating which resource or resources should be enabled or disabled; and
a selective clock module receiving said one or more clock control signals from said control register and enabling and disabling said resource or resources based on said one or more clock control signals.

16. A microprocessor which reduces power surges, comprising:
an instruction cache module;
an instruction fetch module fetching instructions from said instruction cache module;
an execute module executing said instructions fetched by said instruction fetch module;
one or more resources performing tasks;
a system clock supplying system clock signals;
a predictive power ramping module prefetching instructions from said instruction cache and predicting a future time when said one or more resources will need to be changed from a first state to a second state; and
one or more power control modules connected to said one or more resources gradually changing power applied to said connected resources, over a transition time interval, such that said resource is in said second state by at least said future time.

17. The microprocessor of claim 16, wherein said predictive power ramping module comprises:
an instruction prefetch module prefetching from an instruction cache; and
an instruction predecode module decoding the prefetched instruction to predict if said resource will need to be in said second state in said future time.

18. The microprocessor of claim 16, wherein at least one of said power control modules changes power to said connected resource from said first state to an intermediate state over a first transition time interval, keeps said connected resource in said intermediate state for an intermediate time interval, and changes power to said connected resource from said intermediate state to said second state over a second transition time interval.

19. The microprocessor of claim 18, wherein at least one of said first transition time interval, said intermediate time interval, and said second transition time interval is multiple clock cycles long.

20. The microprocessor of claim 16, wherein at least one of said power control modules includes:
a control register receiving one or more external signals and sending out one or more clock control signals indicating which resource or resources should be enabled or disabled; and
a selective clock module receiving said one or more clock control signals from said control register and enabling and disabling said resource or resources based on said one or more clock control signals.
